(19) United States
(12) Patent Application Publication
(10) Pub. No.: US 2009/0308912 A1
(43) Pub. Date: Dec. 17, 2009

(54) DEVICE FOR THE CONTROLLED DISPLACEMENT OF A SPRAY NOZZLE TO INDIVIDUAL SPRAY POINTS, IN PARTICULAR FOR SPRAYING FLUX IN WAVE SOLDERING UNITS

(75) Inventors: Rolf Diehm, Wertheim (DE); Volker Liedke, Leimersheim (DE)

Correspondence Address: HOUSTON ELISEEVA, 4 MILITIA DRIVE, SUITE 4, LEXINGTON, MA, 02421, US

(73) Assignee: SEHO Systemtechnik GmbH, Kreuzwertheim (DE)

(21) Appl. No.: 12/306,617

(22) PCT Filed: Jul. 18, 2007
(86) PCT No.: PCT/EP07/06380

§ 371 Date: Jul. 1, 2009

(30) Foreign Application Priority Data
Aug. 7, 2006 (DE) 102006036773.1

(51) Int. Cl. B23K 3/00

(52) U.S. Cl. 228/33

(57) ABSTRACT

The invention relates to a device for the controlled displacement of an upward-directed spray nozzle to individual spray points that are situated a distance apart, in particular for spraying flux in wave soldering units. The spray nozzle is situated axially on a rotary axle rotated by a rotary drive, to which a deflection force directly radially to the rotary axle is applied in such a way that, when the rotary axle rotates, the spray nozzle executes a self-contained annular motion whose contour is limited in the radial direction by a stationary mask surrounding the spray nozzle.

The invention relates to a device for the controlled displacement of a spray nozzle to individual spray points that are situated a distance apart, in particular for spraying flux in wave soldering units. In soldering units of this type, it is necessary to apply flux selectively to individual soldering points that are distributed irregularly over a p.c. board, depending on the p.c. board to be processed in each case. This applies, in particular, to cases in which individual distributed contact points must be soldered. A spray nozzle that is guided by a two-coordinate drive to the individual solder points where the flux will then be sprayed is ordinarily used for supplying flux to these solder points. The control of such an apparatus necessarily involves a substantial amount of complexity for moving the apparatus in two coordinates and for the programming thereof, according to which the particular coordinates are then calculated with regard to the individual solder points and executed for the purpose of moving the spray nozzle.

The object of the invention is to avoid the substantial complexity of a two-coordinate control system and to simplify the guidance of the spray nozzle. According to the invention, this object is achieved by situating the spray nozzle axially on a rotary axle rotated by a rotary drive, to which a deflection force directed radially to the rotary axle is applied in such a way that, when the rotary axle rotates, the spray nozzle executes a self-contained annular motion whose track is limited in the radial direction by a stationary mask surrounding the spray nozzle.

Using this type of spray nozzle guidance, a track for a self-contained annular motion is assigned to the individual solder points and designed in such a way that the largest possible number of the solder points to be soldered, and thus to be provided with flux, lie on the track. In executing the annular motion, the spray nozzle is then safely guided to the individual solder points, while only the spray nozzle, influenced by the deflection force, runs along the inner edge of the mask, and the deflection force ensures that the spray nozzle or its holder remains in contact with the inner edge of the mask. This eliminates the need for two-coordinate control, since the spray nozzle, safely guided by the mask, executes its contained annular motion and passes over all solder points included in this annular motion along its route.

An advantageous embodiment of the rotary axle having the deflection force applied thereto is achieved by inserting an adjustable angle, including an essentially radial cantilever and an arm connected to the cantilever via a hinge pin, into the rotary axle between the rotary drive and the spray nozzle, the end of the arm supporting the spray nozzle, which is guided in the annular motion limited by the mask, the arm having a radial segment to which the deflection force is applied.

In this embodiment, the deflection force is able to act favorably on the spray nozzle guidance in a way that makes use of the adjustable angle in that the hinge pin connects the radial cantilever to the arm so that the deflection force is able to act upon the arm outwardly in the radial direction, the hinge pin giving the arm the necessary freedom of movement. In this embodiment, the deflection force may be implemented particularly easily in the case of an upward-directed spray nozzle, the deflection force being formed by suspending a weight on the radial segment. Alternatively, it is also possible to suspend a spring on the radial segment which draws the arm outward radially. In both cases, namely using either a spring or a weight, this produces the effect that the arm is drawn outward radially, causing the deflection force to be applied.

According to another advantageous embodiment of the device, a spring that is bent around its longitudinal axis and applies the deflection force is inserted into the rotary axle between the rotary drive and spray nozzle, the spring pressing an area of its end against the inner edge of the mask when the rotary axle rotates, so that the spray nozzle executes the annular motion determined by the mask when the rotary axle rotates. In this embodiment, the bent spring, which is inserted into the rotary axle, is used to generate the deflection force, which ensures that the spray nozzle executes an annular motion defined by the inner edge of the mask. The deflection force generated by the bent spring ensures that the spring nozzle is continuously pressed against the inner edge of the mask when the rotary axle rotates.

To provide different configurations of solder points with flux in the manner described above, a corresponding number of masks may be made available which are used for processing a corresponding p.c. board in the device and thus produce, in each case, a particular desired annular motion of the nozzle, which is guided over the relevant desired solder points.

To enable the spray nozzle to easily supply the sprayed material despite the rotation of the rotary axle supporting the nozzle, the spray nozzle is suitably held by a tube that projects into the mask and is rotatable with respect to the rotary axle, the supply line for the flux is being introduced into the tube through an opening in the tube wall. In this case, the rotary axle is able to rotate without also rotating the spray nozzle, since the latter is held by the rotatable tube, which is held in a non-rotational manner during rotation of the rotary axle, while the rotary axle rotates within the tube, the rotary axle in the tube ensuring that the tube executes the exact annular motion specified by the mask.

Exemplary embodiments of the invention are illustrated in the figures, where:

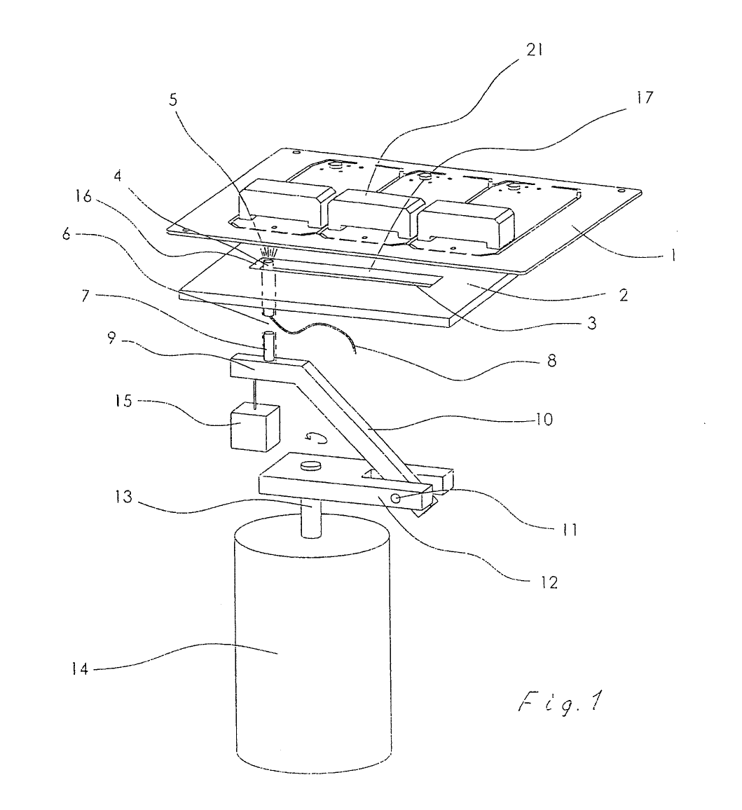

FIG. 1 shows the device having a spring for generating the deflection force;

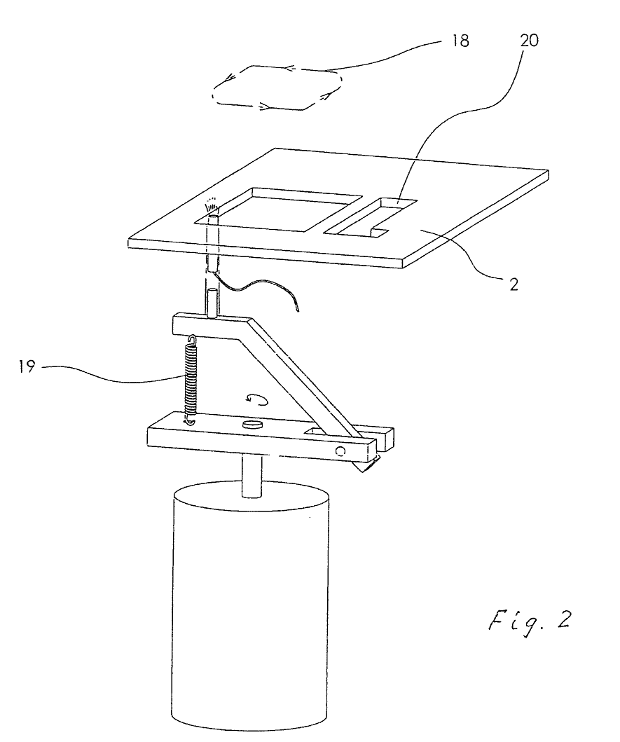

FIG. 2 shows the device having a weight for forming the deflection force;

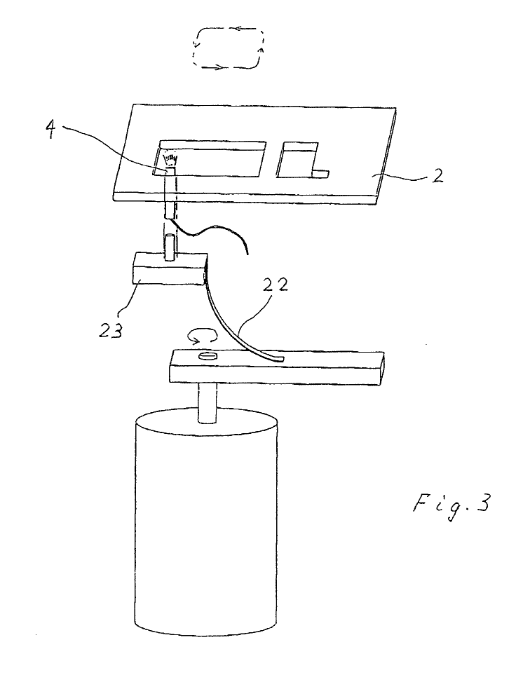

FIG. 3 show the device having a spring that is bent around its longitudinal axis for forming the deflection force.

FIG. 1 shows a p.c. board 1 on which electric components are mounted and from which terminal pins project downward, the terminal pins being soldered to conductor paths attached to the underside of the p.c. board. This involves a conventional technology, which does not need to be discussed in any further detail in this connection.

Mask 2 is held beneath p.c. board 1, and spray nozzle 5 supported by tube 4 projects into inner opening 3 in the mask. Tube 4 is inserted into sleeve 6, which rests on axle stub 7. Due to this bearing arrangement of tube 4 including spray nozzle 5, tube 4 including spray nozzle 5 may be rotated in any direction with respect to axle stub 7. During the movement of tube 4 along the contour of inner opening 3, which is described in further detail below, the rotational position of tube 4 is maintained by a certain tension in supply line 8 for the flux to be sprayed. This flux therefore reaches spray nozzle 5 via supply line 8, and the spray nozzle sprays the flux upward in the direction of p.c. board 1.

Axle stub 7 is supported by arm end 9 of arm 10, which is connected to cantilever 12 via hinge pin 11. Cantilever 12 rests on rotary axle 13, which projects from rotor drive 14 and to which a rotary motion is imparted by the rotor drive.

The device described above is based on the following function: Rotary drive 14 rotates rotary axle 13 and thus also cantilever 12. Axle stub 7 is also rotated, due to the connection of cantilever 12 via hinge pin 11, arm 10 and arm end 9. The motion of axle stub 7 is limited by the inner contour of inner opening 3 in the mask, axle sub 7, sleeve 6 and tube 4 being pulled to the left, due to the effect of weight 15 in the position illustrated in FIG. 1, until tube 4 comes to rest against inner wall 16 of mask 2. If rotor drive 14 now imparts a rotary motion to its axle 13, and thus to tube 4, tube 4 must following this rotary motion in such a way that tube 4 slides along inner wall 16 of mask 2 until it comes into contact with inner surface 17 of mask 2 as axle 13 rotates in the direction of the illustrated arrow. The axle stub and thus tube 4 each assume a slightly different oblique position, which, however, is practically irrelevant for spraying flux. In any case, the illustrated design provides tube 4 and nozzle 5 resting thereon enough motion clearance that, when axle 13 rotates, tube 4 passes over the inner surfaces of mask 2, i.e., in particular, surfaces 16 and 17, nozzle 5 executing a ring motion that guides it, according to mask 2, over all the solder points on p.c. board 1 that are to be soldered later on with the aid of illustrated mask 2. The path traveled by nozzle 5 is indicated above p.c. board 1 as a broken line provided with arrows in the shape of a rectangular ring 18 (see FIG. 2). The pressure acting upon the inner surfaces of mask 2 in the device according to FIG. 1 is applied by weight 15. Instead of the weight, it is also possible to use a tension spring 19, as illustrated in FIG. 2, which is anchored on cantilever 12 and on end 9 of arm 10 and—like the effect of weight 15 according to FIG. 1—pulls arm 10 against cantilever 12. As in the case of the device according to FIG. 1, the pressure acting upon tube 4 is produced in the direction of the inner surfaces of mask 2. Excluding the area encompassing inner opening 3, the mask is provided with a further area 20 to be traversed, it being necessary to relocate mask 2 accordingly in order for tube 4 to traverse the area.

In the device illustrated in FIG. 3, the deflection force is generated by bent spring 22, which presses against support 23 and therefore presses tube 4 supported by support 22 against the inner surfaces of mask 2. In other respects, the function of the device according to FIG. 3 corresponds to the function of the devices described above, so that reference is hereby made to the relevant descriptions.

1. A device for the controlled displacement of an upward-directed spray nozzle (5) to individual spray points that are spaced a distance apart, in particular for spraying flux in wave soldering units, characterized in that the spray nozzle (5) is situated axially on a rotary axle (13, 7) rotated by a rotary drive (14), to which a deflection force directed radially to the rotary axle (13, 7) is applied in such a way that, when the rotary axle (13, 7) rotates, the spray nozzle (5) executes a self-contained annular motion (18) whose contour is limited in the radial direction by a stationary mask (2) surrounding the spray nozzle (5).

2. The device according to claim 1, characterized in that an adjustable angle having an essentially radial cantilever (12) and having an arm (10) connected to the cantilever (12) via a hinge pin (11) is inserted into the rotary axle (13, 7) between the rotary drive (14) and the spray nozzle (5), the end (9) of the arm supporting the spray nozzle (5), which is guided in the annular motion (18) limited by the mask (2), the arm (10) including a radial segment (9) to which the deflection force is applied.

3. The device according to claim 2, characterized in that a weight (15) is suspended on the radial segment (19 [sic; 9]) for producing the deflection force.

4. The device according to claim 2, characterized in that a spring (19) is suspended on the radial segment for forming the deflection force.

5. The device according to claim 1, characterized in that a spring producing the deflection force, which is bent around its longitudinal axis, is inserted between the rotary axle (13, 7) and the spray nozzle (5), the spring pressing an area of its end against the inner wall (16, 17) of the mask (2) when the rotary axle (13, 7) rotates, so that the spray nozzle (5) executes the annular motion (18) determined by the mask (2) when the rotary axle (13, 7) rotates.

6. The device according to claim 1, characterized in that the annular motion (18, 20) of the spray nozzle (5) is determined by different masks (2) that are used alternately.

7. The device according to claim 1, characterized in that the spray nozzle (5) is supported by a tube (4), which is rotatable with respect to the rotary axle (13, 7) and which projects into the mask (2), a supply line (8) for the flux being introduced into the tube through an opening in the wall of the tube (4).

8. The device according to claim 2, characterized in that the annular motion (18, 20) of the spray nozzle (5) is determined by different masks (2) that are used alternately.

9. The device according to claim 3, characterized in that the annular motion (18, 20) of the spray nozzle (5) is determined by different masks (2) that are used alternately.

10. The device according to claim 4, characterized in that the annular motion (18, 20) of the spray nozzle (5) is determined by different masks (2) that are used alternately.

11. The device according to claim 5, characterized in that the annular motion (18, 20) of the spray nozzle (5) is determined by different masks (2) that are used alternately.

12. The device according to claim 2, characterized in that the spray nozzle (5) is supported by a tube (4), which is rotatable with respect to the rotary axle (13, 7) and which projects into the mask (2), a supply line (8) for the flux being introduced into the tube through an opening in the wall of the tube (4).

13. The device according to claim 3, characterized in that the spray nozzle (5) is supported by a tube (4), which is rotatable with respect to the rotary axle (13, 7) and which projects into the mask (2), a supply line (8) for the flux being introduced into the tube through an opening in the wall of the tube (4).

14. The device according to claim 4, characterized in that the spray nozzle (5) is supported by a tube (4), which is rotatable with respect to the rotary axle (13, 7) and which projects into the mask (2), a supply line (8) for the flux being introduced into the tube through an opening in the wall of the tube (4).

15. The device according to claim 5, characterized in that the spray nozzle (5) is supported by a tube (4), which is rotatable with respect to the rotary axle (13, 7) and which projects into the mask (2), a supply line (8) for the flux being introduced into the tube through an opening in the wall of the tube (4).

16. The device according to claim 6, characterized in that the spray nozzle (5) is supported by a tube (4), which is rotatable with respect to the rotary axle (13, 7) and which projects into the mask (2), a supply line (8) for the flux being introduced into the tube through an opening in the wall of the tube (4).
